(19) United States
(12) Patent Application Publication
(10) Pub. No.: US 2025/0150754 A1
(43) Pub. Date: May 8, 2025

(54) SPHERICAL SPEAKER

(71) Applicant: TGI Technology PTE LTD, Cote d'Azur (SG)

(72) Inventor: Shihuang LI, Cote d'Azur (SG)

(21) Appl. No.: 19/012,138

(22) Filed: Jan. 7, 2025

Related U.S. Application Data
(63) Continuation-in-part of application No. PCT/SG2023/050171, filed on Mar. 16, 2023.

(30) Foreign Application Priority Data
Jul. 7, 2022 (CN) 202221741304.X

(51) Int. Cl. H04R 1/28

(52) U.S. Cl. CPC H04R 1/2834; H04R 1/2826; H04R 2201/029

(57) ABSTRACT

A spherical speaker includes an injection-molded shell, a passive diaphragm unit, and a speaker unit. The diaphragm part of the passive diaphragm unit is blow-molded to form an arc surface with the same curvature as the surface of the injection-molded shell. The injection-molded shell includes a mounting opening for the passive diaphragm unit, with the diaphragm part of the passive diaphragm unit exposed outside the mounting opening, forming a continuous spherical surface with the shell. This spherical speaker ensures that the installation of the passive diaphragm unit does not compromise the surface continuity of the spherical shell.

### CROSS-REFERENCE TO RELATED APPLICATIONS AND PRIORITY

This patent application is a Continuation-in-Part of PCT Application No. PCT/SG2023/050171 filed Mar. 16, 2023, which claims priority from Chinese Patent Application No. 202221741304.X filed Jul. 7, 2022. Each of these patent applications are herein incorporated by reference in their entirety.

### TECHNICAL FIELD

This disclosure relates to a sound-emitting device, specifically to a speaker.

### BACKGROUND TECHNOLOGY

Traditional passive diaphragm units often have flat diaphragms. When installing such a diaphragm on a speaker shell with a curved surface, the diaphragm disrupts the shell's surface continuity. This results in many compromises in the speaker's external design.

### SUMMARY

The main technical problem this disclosure aims to solve is providing a spherical speaker that maintains the surface continuity of the spherical shell when the passive diaphragm unit is installed.

To address the above problem, this disclosure provides a spherical speaker having:
An injection-molded shell,
A passive diaphragm unit, and
A speaker unit.

The diaphragm portion of the passive diaphragm unit is blow-molded to form an arc surface with the same curvature as the surface of the injection-molded shell. The injection-molded shell has a mounting opening for the passive diaphragm unit, with the diaphragm portion of the passive diaphragm unit exposed outside the mounting hole, forming a continuous spherical surface with the shell.

### PREFERRED EMBODIMENTS

### In a Preferred Embodiment

The diaphragm portion of the passive diaphragm unit is adhesively connected to a fixing ring. The fixing ring has an extension surface with the same curvature as the injection-molded shell. The extension surface is adhesively bonded to the inner surface of the injection-molded shell.

### In Another Preferred Embodiment

The injection-molded shell includes an opening for installing the speaker unit.

### In Yet Another Preferred Embodiment

The speaker unit is divided into a bass speaker unit and a treble speaker unit.

### PREFERRED EMBODIMENTS OF THE SPHERICAL SPEAKER

### Axial Arrangement of Speaker Units

In a preferred embodiment, the treble speaker unit and the bass speaker unit are arranged vertically along the axial direction of the injection-molded shell.

### Dual Passive Diaphragm Units

In another preferred embodiment, two passive diaphragm units are arranged horizontally along the axial direction of the injection-molded shell, positioned symmetrically on either side.

### Suspension Feature

In a preferred embodiment, the injection-molded shell is equipped with a strap designed for suspending the spherical speaker.

### Larger Passive Diaphragm Area

In a preferred embodiment, the passive diaphragm unit has a larger surface area compared to either the bass speaker unit or the treble speaker unit.

### Structure and Composition of the Speaker

This embodiment provides a spherical speaker composed of a shell, a passive diaphragm unit, and a speaker unit:

The diaphragm portion of the passive diaphragm unit forms an arc surface with the same curvature as the shell's surface.

The shell includes a mounting opening for the passive diaphragm unit, with the diaphragm portion exposed outside the mounting hole, forming a continuous spherical surface with the shell.

The passive diaphragm unit is equipped with a counterweight block on the side facing the mounting hole. The counterweight block is penetrated by a flow-through port along its thickness direction.

### Fixation of the Passive Diaphragm Unit

In a preferred embodiment, the diaphragm portion of the passive diaphragm unit is fixedly connected to a fixing ring using adhesive. The fixing ring has an extension surface with the same curvature as the shell's surface, and this extension surface is bonded to the inner surface of the shell using adhesive.

### Mounting Openings for Speaker Units

The injection-molded shell includes an opening for installing the speaker unit.

### Division of Speaker Units

In a preferred embodiment, the speaker unit is divided into a bass speaker unit and a treble speaker unit.

### Axial Placement of Speaker Units

The treble and bass speaker units are arranged vertically along the axial direction of the injection-molded shell.

### Placement of Dual Passive Diaphragm Units

In a preferred embodiment, the two passive diaphragm units are positioned horizontally along the axial direction of the injection-molded shell.

### Relative Size of Passive Diaphragm Units

In a preferred embodiment, the passive diaphragm unit has a larger area than either the bass speaker unit or the treble speaker unit.

In a preferred embodiment, the counterweight block is ring-shaped and coaxial with the diaphragm portion of the passive diaphragm unit, with the flow-through port located at its center.

Compared to existing technologies, this spherical speaker offers the following advantages:

The spherical speaker with the diaphragm portion of the passive diaphragm unit exposed outside the mounting opening of the injection-molded shell, forms a continuous spherical surface with the shell. This ensures the vibration of the passive diaphragm unit is visible without disrupting the spherical shape of the speaker.

The spherical speaker uses a blow-molded diaphragm, which creates an outwardly convex chamber. This chamber has a small opening and a larger body, allowing a large passive diaphragm to connect to a small rubber fixing ring. The size of the fixing ring determines the size of the mounting opening on the shell, enabling the use of a large passive diaphragm while keeping the mounting opening small.

The spherical speaker employs a blow-molded diaphragm that is thin and lightweight, ensuring that increasing the size of the passive diaphragm does not shift the speaker's center of gravity.

The spherical speaker incorporates a counterweight block to increase the weight of the passive diaphragm unit, ensuring proper sagging after installation. The counterweight block directs airflow exclusively through the flow-through port to drive the vibration of the diaphragm portion. By aligning the counterweight block coaxially with the diaphragm portion, the flow-through port aligns with the center of the diaphragm, optimizing airflow to drive the diaphragm's vibration effectively.

### BRIEF DESCRIPTION OF THE FIGURES

FIG. 1: A perspective view of embodiment 1 of the spherical speaker.

FIG. 2: A sectional view of embodiment 1 of the spherical speaker.

FIG. 3: A partial enlarged view of FIG. 2.

FIG. 4: A perspective view of embodiment 2 of the spherical speaker.

FIG. 5: A sectional view of embodiment 2 of the spherical speaker.

FIG. 6: A schematic diagram of the passive diaphragm unit in embodiment 2 of the spherical speaker.

FIG. 7: A sectional view of the passive diaphragm unit in embodiment 2 of the spherical speaker.

### DETAILED DESCRIPTION OF THE FIGURES

Below, the technical solutions in the embodiments of the spherical speaker will be clearly and completely described in conjunction with the accompanying figures. It is evident that the described embodiments are merely part of the utility model and not all of them. Based on the disclosed embodiments of the spherical speaker, all other embodiments that a person skilled in the art can derive without creative work shall fall within the scope of protection of the spherical speaker.

In the description of this spherical speaker, it should be noted that terms such as “upper,” “lower,” “inner,” “outer,” “top/bottom end,” etc., are used to indicate positional or spatial relationships based on the positions shown in the accompanying figures. These terms are provided for the convenience of describing the utility model and simplifying the explanation. They do not indicate or imply that the referenced components or elements must have specific positions, be constructed, or operate in specific orientations and therefore should not be interpreted as limitations to the spherical speaker. Additionally, the terms “first” and “second” are used only for descriptive purposes and should not be understood as indicating relative importance.

### Embodiment 1

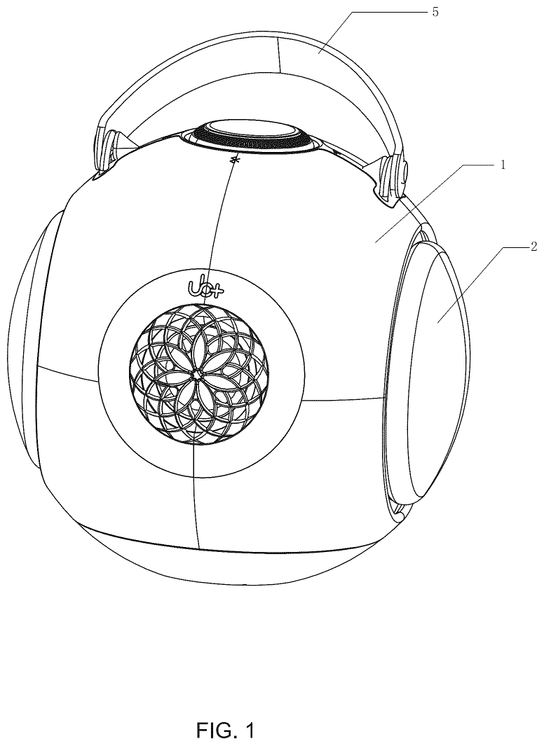

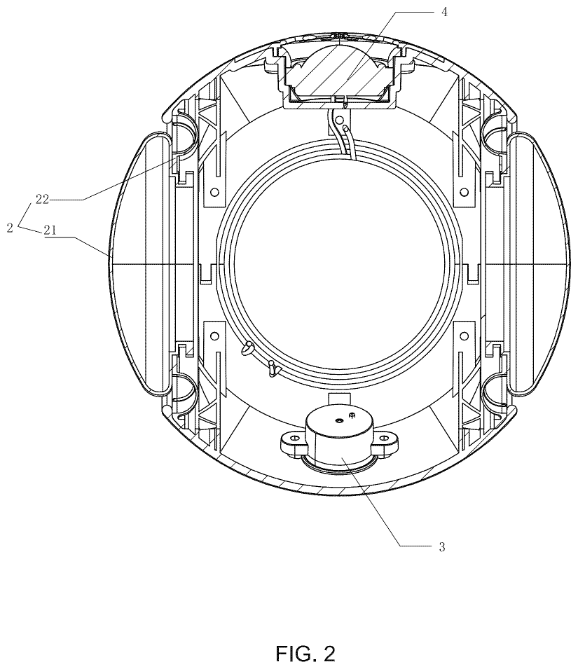

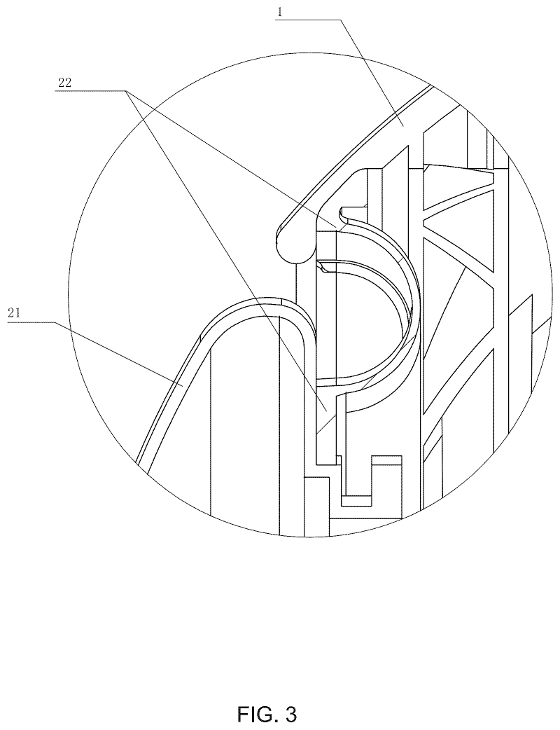

Referring to FIGS. 1-3, this embodiment provides a spherical speaker comprising:
An injection-molded shell (1),
A passive diaphragm unit (2), and
A speaker unit.

The diaphragm portion (21) of the passive diaphragm unit (2) is blow-molded to form an arc surface with the same curvature as the surface of the injection-molded shell (1). The injection-molded shell (1) includes a mounting opening for the passive diaphragm unit (2), with the diaphragm portion (21) exposed outside the mounting opening, forming a continuous spherical surface with the shell (1).

In this spherical speaker, the diaphragm portion (21) of the passive diaphragm unit (2) is exposed outside the mounting opening of the injection-molded shell (1), forming a seamless spherical surface. This design visualizes the vibrations of the passive diaphragm unit (2) without compromising the spherical appearance of the speaker. Additionally, since the diaphragm portion (21) is blow-molded, it forms an outwardly convex chamber with a small opening and a larger body. This allows a large passive diaphragm to connect to a small-sized rubber fixing ring (22).

The size of the fixing ring (22) determines the size of the mounting opening on the injection-molded shell (1). Consequently, this enables the installation of a large passive diaphragm while keeping the mounting opening small.

Furthermore, the blow-molded diaphragm (21) is thin and lightweight, ensuring that increasing the diaphragm's area does not shift the center of gravity of the speaker. Therefore, in this embodiment, the area of the passive diaphragm unit (2) can be larger than that of the speaker unit.

To secure the passive diaphragm, the diaphragm portion (21) of the passive diaphragm unit (2) is adhesively connected to the fixing ring (22) of the passive diaphragm unit (2). Additionally, to fix the entire passive diaphragm unit (2) to the injection-molded shell (1), the fixing ring (22) has an extension surface with the same curvature as the surface of the injection-molded shell (1).

This extension surface is adhesively bonded to the inner surface of the injection-molded shell (1).

### Embodiment 2

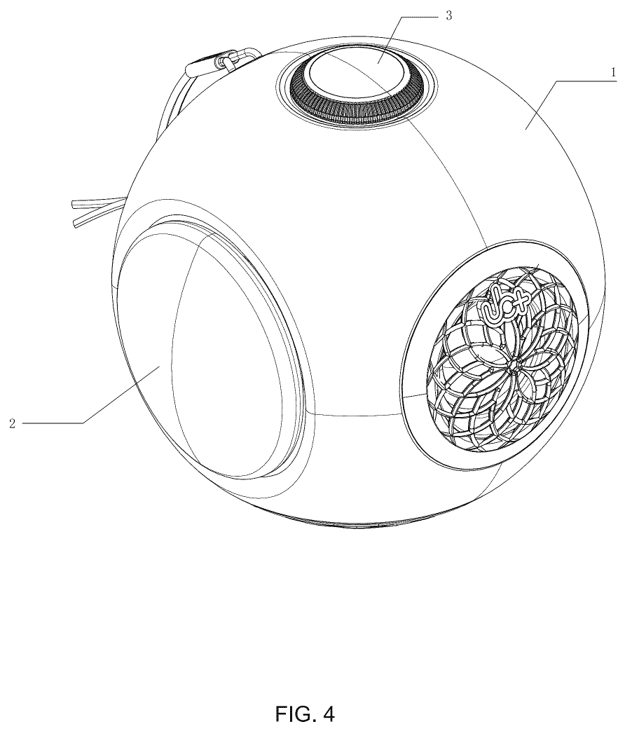

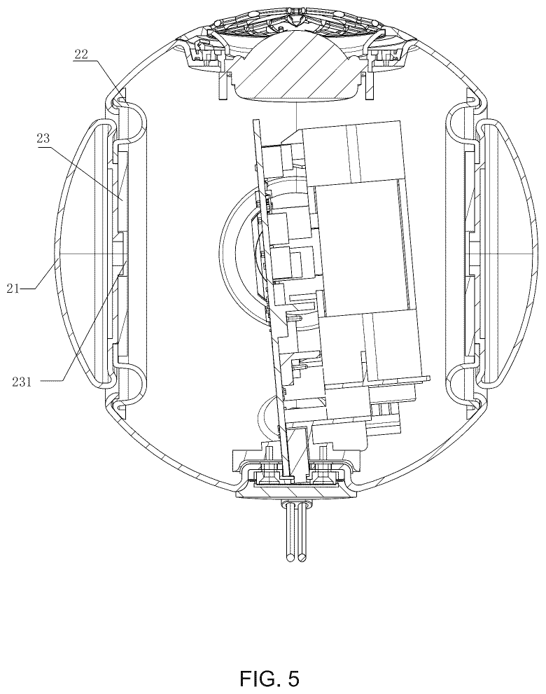

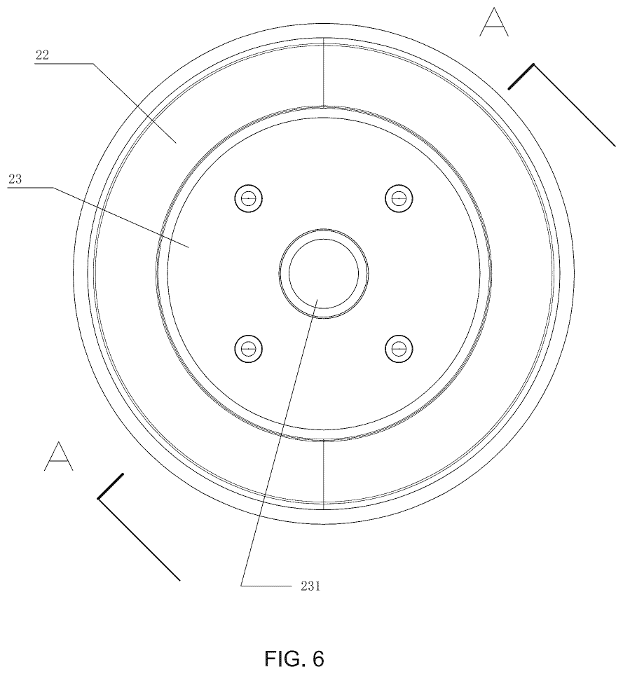

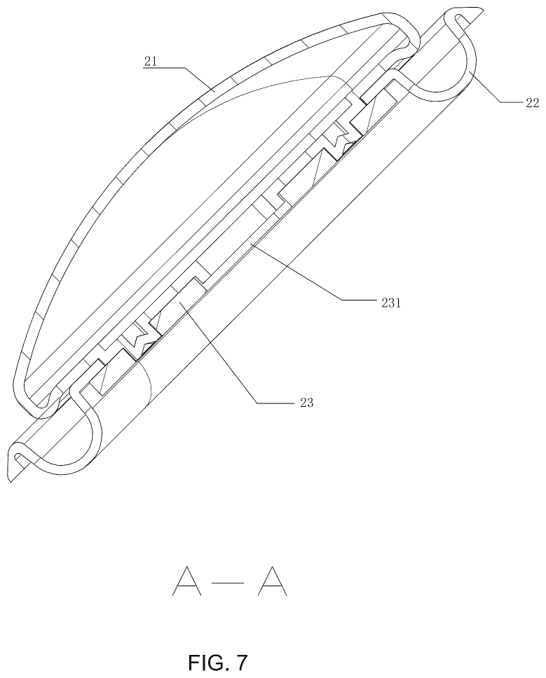

Referring to FIGS. 4-7, this embodiment provides a spherical speaker comprising:
A shell (1),
A passive diaphragm unit (2), and
A speaker unit (3).

The diaphragm portion (21) of the passive diaphragm unit (2) is blow-molded to form an arc surface with the same curvature as the surface of the shell (1). The shell (1) has a mounting opening for the passive diaphragm unit (2), with the diaphragm portion (21) exposed outside the mounting opening, forming a continuous spherical surface with the shell (1).

In this spherical speaker, the diaphragm portion (21) of the passive diaphragm unit (2) is exposed outside the mounting opening of the shell (1), forming a seamless spherical surface. This design allows the vibration of the passive diaphragm unit (2) to be visualized while maintaining the spherical appearance of the speaker. Additionally, since the diaphragm portion (21) is blow-molded, it forms an outwardly convex chamber. This chamber has a small opening and a larger body, enabling a large passive diaphragm to connect to a small-sized rubber fixing ring (22). The size of the rubber fixing ring (22) determines the size of the mounting opening on the shell (1).

Thus, a large passive diaphragm can be installed with a smaller mounting opening on the shell (1).

Furthermore, the diaphragm portion (21), which is prepared through blow molding, is thin and lightweight. This ensures that increasing the area of the passive diaphragm does not shift the center of gravity of the entire speaker. Therefore, in this embodiment, the area of the passive diaphragm unit (2) can be larger than that of the speaker unit (3).

In this embodiment, to secure the passive diaphragm, the diaphragm portion (21) of the passive diaphragm unit (2) is fixedly connected to the fixing ring (22) of the passive diaphragm unit (2) using adhesive. To secure the entire passive diaphragm unit (2) to the shell (1), the fixing ring (22) has an extension surface with the same curvature as the surface of the shell (1). This extension surface is adhesively bonded to the inner surface of the shell (1).

In this embodiment, a counterweight block (23) is provided on the side of the passive diaphragm unit (2) facing the mounting opening of the shell (1). The counterweight block (23) has a flow-through port (231) penetrating its thickness direction. Specifically, the counterweight block (23) is ring-shaped and coaxial with the diaphragm portion (21) of the passive diaphragm unit (2), with the flow-through port (231) located at its center.

By incorporating the counterweight block (23), the weight of the passive diaphragm unit (2) is increased, ensuring proper sagging after installation on the shell (1). Additionally, the counterweight block (23) ensures that air within the shell (1) flows exclusively through the flow- through port (231) to drive the vibration of the diaphragm portion (21) of the passive diaphragm unit (2). By aligning the counterweight block (23) coaxially with the diaphragm portion (21) of the passive diaphragm unit (2), the flow-through port (231) aligns with the center of the diaphragm portion (21), allowing the airflow to more effectively drive the vibrations of the diaphragm portion (21).

The remaining aspects are the same as those described in Embodiment 1 and are not repeated here.

The above description is merely a preferred specific embodiment of the spherical speaker. The design concept of the spherical speaker is not limited to this. Any technical personnel familiar with this field can make insubstantial modifications to the spherical speaker based on the disclosed technical scope, and such modifications fall within the protection scope of the spherical speaker.

1. A spherical speaker comprising an injection-molded shell, a passive diaphragm unit, and a speaker unit;
wherein the diaphragm portion of the passive diaphragm unit is blow-molded to form an arc surface with a curvature matching a surface of the injection-molded shell, wherein the injection-molded shell has a mounting opening for the passive diaphragm unit, with the diaphragm portion of the passive diaphragm unit exposed outside the mounting opening, forming a continuous spherical surface with the shell.

2. The spherical speaker of claim 1, wherein the diaphragm portion of the passive diaphragm unit is fixedly connected to a fixing ring of the passive diaphragm unit using adhesive, wherein the fixing ring has an extension surface with a curvature matching the surface of the injection-molded shell, and the extension surface is adhesively connected to an inner surface of the injection-molded shell.

3. The spherical speaker of claim 1, wherein the injection-molded shell further comprises an opening for receiving the speaker unit.

4. The spherical speaker of claim 3, wherein the speaker unit further comprises a bass speaker unit and a treble speaker unit.

5. The spherical speaker of claim 4, wherein the treble and bass speaker units are arranged axially, vertically, along the injection-molded shell.

6. The spherical speaker of claim 5, wherein the passive diaphragm unit comprises two units, which are arranged axially along the injection-molded shell on a left side and a right side.

7. The spherical speaker of claim 1, wherein the injection-molded shell is connected with a strap for suspending the spherical speaker.

8. The spherical speaker of claim 4, wherein a volume of the passive diaphragm unit is larger than area volume of the bass speaker unit or the treble speaker unit.

9. A spherical speaker comprising a shell, a passive diaphragm unit, and a speaker unit, wherein the diaphragm portion of the passive diaphragm unit forms an arc surface with a curvature matching a curvature of the shell, wherein the shell has a mounting opening for receiving the passive diaphragm unit, with the diaphragm portion of the passive diaphragm unit exposed outside the mounting opening, forming a continuous spherical surface with the shell.

10. The spherical speaker of claim 9, The diaphragm portion of the passive diaphragm unit is fixedly connected to the fixing ring of the passive diaphragm unit using adhesive. The fixing ring has an extension surface with the same curvature as the surface of the injection-molded shell, and the extension surface is adhesively connected to the inner surface of the injection-molded shell.

11. The spherical speaker of claim 9, wherein the injection-molded shell further includes an opening for receiving the speaker unit.

12. The spherical speaker of claim 11, wherein the speaker unit further comprises a bass speaker unit and a treble speaker unit.

13. The spherical speaker of claim 12, wherein the bass and treble speaker units are arranged axially, vertically, along the injection-molded shell.

14. The spherical speaker of claim 9, wherein the passive diaphragm unit consists of two units, which are arranged axially along the injection-molded shell on a left side and a right side.

15. The spherical speaker of claim 12, wherein a volume of the passive diaphragm unit is larger than area volume of the bass speaker unit or the treble speaker unit.

16. The spherical speaker of claim 9, wherein the passive diaphragm unit further comprises a ring-shaped counterweight block with a center containing a flow-through port.
